(19) United States
(12) Patent Application Publication
(10) Pub. No.: US 2002/0124673 A1
(43) Pub. Date: Sep. 12, 2002

(54) Impact absorber of a gears-transmission apparatus

(76) Inventors: Shih-Lin Yeh, Taipei (TW); Tsing-Sung Hsu, Taipei (TW); Yi-Cheng Tsao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/800,727

(22) Filed: Mar. 8, 2001

(51) Int. Cl. F16H 55/14; F16H 57/00

(52) U.S. Cl. 74/443; 74/411

(57) ABSTRACT

An impact absorber of a gears-transmission apparatus is disclosed. A gear section in the system is consisted of two rotary units, which are rotating with each other dependently. An elastic element is mounted between these two rotary units so that the mechanism is able to restore to the original position after the external torque being released. Thereby, under the condition without increasing the room available for mechanism design, the transmission apparatus possesses nice performance as a rubber belt for impact buffer from abrupt braking, instantaneous accelerating and collision . . . etc. Therefore, damage to the gear transmission system is effectively prevented so as the whole driving movement is smoother and the noise from collision of the components are also reduced.

### FIELD OF THE INVENTION

The present invention relates to an impact absorber of a gears-transmission apparatus. A rubber belt is suitable for impact bumper design but easy to weariness and aging. On the other hand, a traditional gears-transmission apparatus can work longer but louder noise induced from gear backlash and damage due to abnormal impact are unpleasant side effects. The present invention aims to possess the advantages of a rubber belt for impact buffer with longer lifetime from abrupt braking, instantaneous accelerating and collision . . . etc under the consideration of compact size design. Therefore, damage to the gear transmission system is effectively prevented so as the whole driving movement is smoother and the noise from collision of the components are also reduced.

### BACKGROUND OF THE INVENTION

The gears-transmission apparatus is used in business machines or peripherals of computer products, such as optical disk drives, scanners, etc., for a long time. In some applications, a rubber belt is used to replace gears in the transmission system because quiet noise quality is required. For a tray loading function of an optical disk drive, a small rubber belt is usually designed to provide an impact buffer from abrupt braking, instantaneous accelerating . . . etc. Therefore, the damage to the transmission device, for examples, gear-teeth bending, motor's over current, damage of a detect switch . . . etc. is prevented therefore the driving movement is smoother and the noise from the collision of components is greatly reduced. The possibility of the disk falling due to the collision of the optical disk is also reduced greatly. However, the lifetime of a rubber belt is shorter than gear and the sliding of the belt on pulley will induce some scraps so as to affect functions of nearby components. On the other hand, the lifetime by using gears system is prolonged, but some side effects should be further overcome.

Accordingly, there is an eager demand for a novel design of an impact absorber of a gears-transmission apparatus, which can improve the defect of the prior art design.

### SUMMARY OF THE INVENTION

Accordingly, the primary object of the present invention is to provide an impact absorber of a gears-transmission system, wherein under the condition of without increasing the space allocation, the system has the advantages of a rubber belt for buffering the impact from abrupt stopping, instantaneous accelerating, colliding, etc. Therefore, the damage to the gear system is prevented so that the whole driving action is smoother, and the noise from the collision of the components is reduced.

To achieve the aforesaid object, the present invention provides an impact absorber of a new gears-transmission apparatus. A gear section in a gear driving system is formed as two rotary units, which are capable of rotating with each other. The reduction ratio of the two rotary units is designed according to practical consideration. An elastic element is installed between the two rotary units so that when a torque applies to the two rotary units, the two rotary units have the ability to restore to the original relative position. The different elastic element will cause a different effect as used with different rubber belt having different hardness and width. When the rotary units reach the maximum rotation angle, the driving system does not rotate through a corresponding angle, then strength of the elastic element can be adjusted properly.

Various objects and advantages of the present invention will be more readily understood from the following detailed description when read in conjunction with the appended drawing.

### BRIEF DESCRIPTION OF THE DRAWINGS

FIG. 1 is a top view of the first embodiment in the present invention.

FIG. 2 is a cross-sectional view along line A-A in FIG. 1.

FIG. 3 is a cross-sectional view along line B-B in FIG. 1.

FIG. 4 is a 2-D exploding view of the first embodiment in the present invention.

FIG. 5 is an exploded perspective view of the first embodiment in the present invention.

FIG. 6 is a top view of the second embodiment in the present invention.

FIG. 7 is a cross-sectional view along A-A of FIG. 6.

FIG. 8 is a 2-D exploding view of the second embodiment in the present invention.

FIG. 9 is an exploded perspective view of the second embodiment in the present invention.

### DETAILED DESCRIPTION OF THE PREFERRED EMBODIMENTS

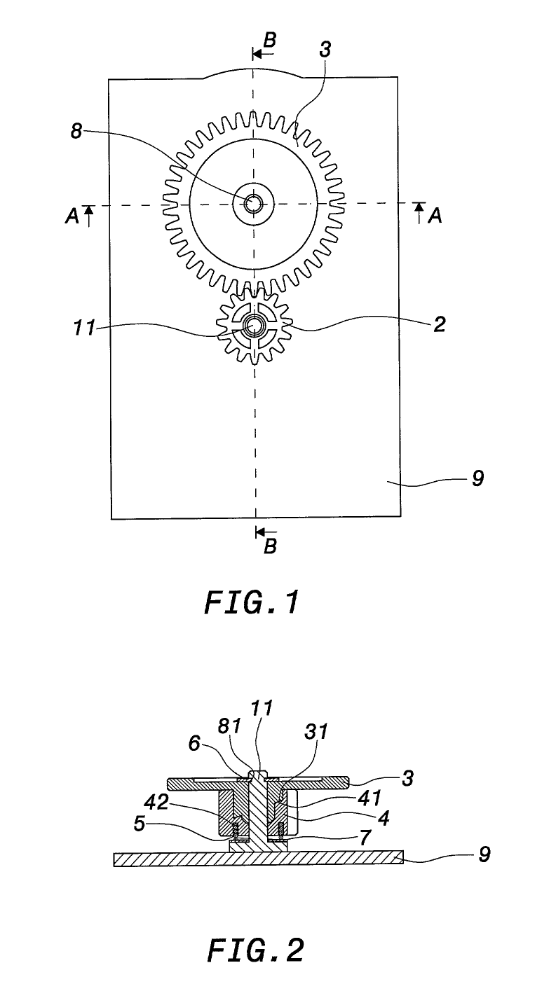

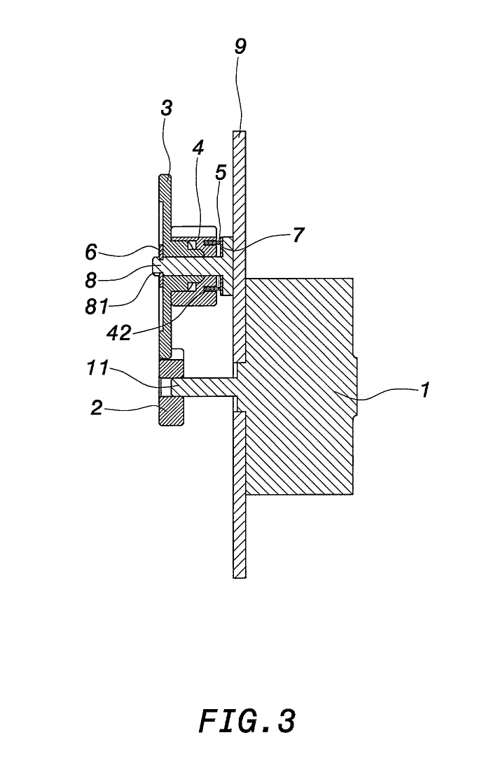

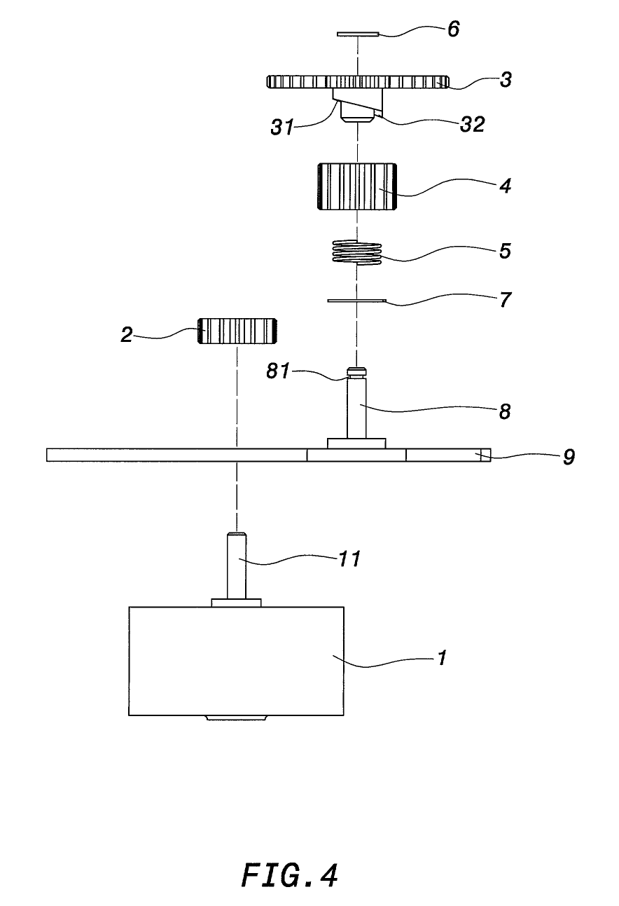

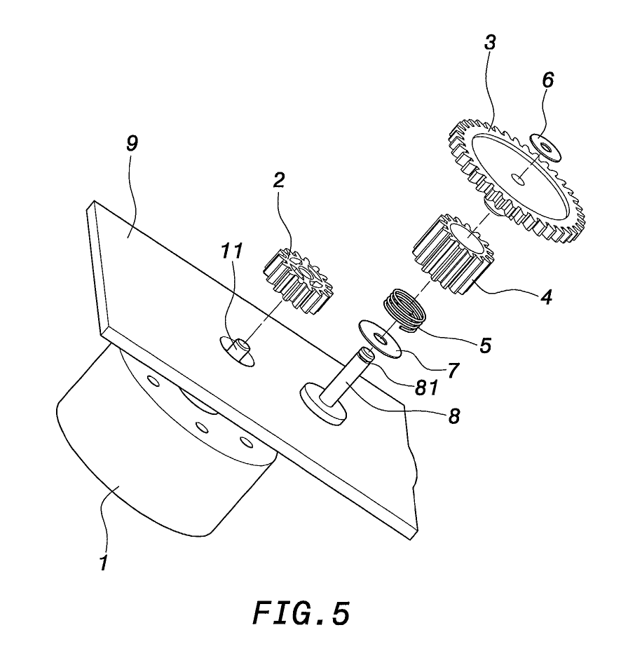

With reference to FIGS. 1 to 5, the impact absorber of a gears-transmission apparatus of the present invention is illustrated. The impact absorber includes a motor 1, a dynamic gear 2, a first rotary unit 3, a second rotary unit 4, an elastic element 5, a retaining ring 6, a washer 7, and a shaft 8. The motor 1 is properly fixed to a body 9. The dynamic gear 2 is tightly matched to the spindle 11 of the motor 1 for outputting dynamic force of the motor 1.

The shaft 8 is protruded individually or integrally formed from the body 9. The first rotary unit 3 and second rotary 4 are gears, which are engaged with the shaft 8. The first rotary unit 3 is engaged with the dynamic gear 2 so that the dynamic force of the motor 1 can be transferred to the first rotary unit 3 through the dynamic gear 2. The first rotary unit 3 and second rotary unit 4 may rotate and slide with respect to one another. The first rotary unit 3 and second rotary unit 4 is rotatable on the shaft 8. The retaining ring 6 is buckled to the annular groove 81 preset on the shaft 8 for confining the first rotary unit 3 on the shaft 8.

One side of the second rotary unit 4 is installed with a receiving groove 42. Moreover, another end of the elastic element 5 protrudes from the receiving groove 42 with an appropriate length so that the elastic element 5 can be placed between the body 9 and the second rotary unit 4. The elastic element 5 does not be confined to the aforesaid means, it may be a linear spring, a plate spring, a twisted spring, or elastic elements of other types.

The first rotary unit 3 and second rotary unit 4 are installed with a first inclined surface 31 and a second inclined surface 41, respectively, which are contacted with one another. The first inclined surface 31 and the second inclined surface 41 of the first rotary unit 3 and second rotary unit 4 are not confined to the shown inclined angles which can be adjusted as required so that as the first rotary unit 3 and second rotary unit 4 rotates with respect to one another, the second rotary unit 4 may axially extrude the elastic element 5. The elastic element 5 suffers from a pressure so that the first rotary unit 3 and second rotary unit 4 have a tendency to restore to the original pint. The washer 7 is installed between one end of the elastic element 5 and the body 9 so that the rotation is more successful so as to confine the relative rotation of the first rotary unit 3 and the second rotary unit 4. Moreover, a tenon 32 is installed on the first inclined surface 31 for confining a maximum relative rotation angle of the first rotary unit 3 to the second rotary unit 4.

The dynamic force of the motor 1 is transferred through the dynamic gear 2 and the first rotary unit 3 and then outputted from the second rotary unit 4 or the dynamic force is transferred through an inverse direction. Therefore, an abrupt impact can be absorbed by the elastic element 5.

In the present invention, some gear section in the gear driving system is classified into two rotary portions. Furthermore, the relative rotary angle can be designed as request. The elastic element 5 between the first rotary unit 3 and the second rotary unit 4 will cause the rotary units to restore to the original place as a torque is applied thereon. The different elastic element 5 will cause a different effect as used with different rubber belt having different hardness and width. When the rotary units 3 and 4 arrives to a maximum rotation angle, while the driving system does not rotate through a corresponding angle, then the length or strength of the elastic element 5 can be adjusted properly.

In the present invention, under the condition without increasing the space, the gear transmission system has the advantages of a rubber belt for buffering the impact from an abrupt stopping, instantaneous accelerating, colliding, etc. Therefore, the damage to the gear driving system is prevented so that the whole driving action is more smooth, and the noise from the collision of the components are reduced.

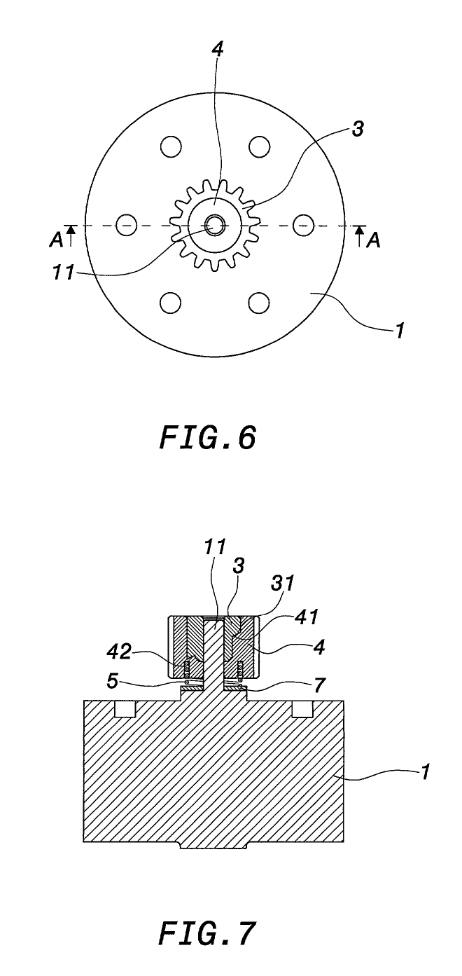

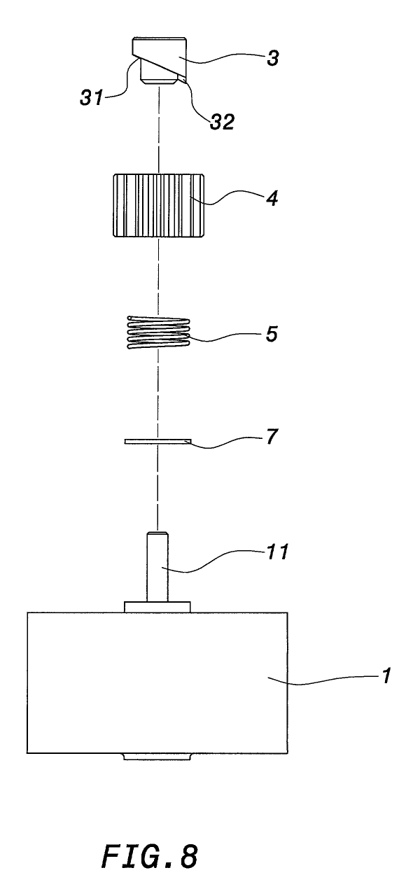

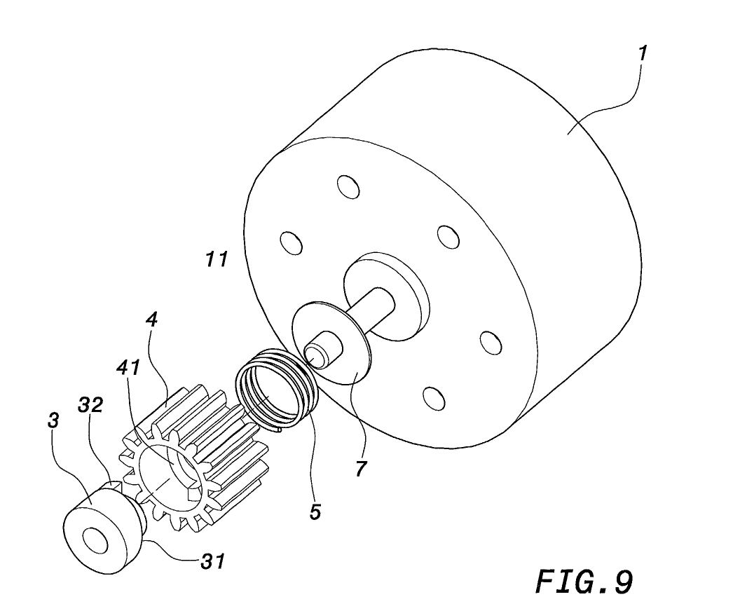

Referring to FIGS. 6 to 9, the second embodiment of the impact absorber of a gear driving system in the present invention is illustrated. The impact absorber of a gear driving system of the present invention can be applied to a spindle of a motor. In this embodiment, the present invention has a motor 1, a first rotary unit 3, a second rotary unit 4, an elastic element 5, a washer 7. The first rotary unit 3 is an active buckle and is tightly matched to the motor spindle 11 of the motor 1. The second rotary 4 is a gear. The first rotary unit 3 and second rotary unit 4 may rotate and slide with respect to one another. One side of the second rotary unit 4 is circularly installed with a receiving groove 42. One end of the elastic element 5 is received in the receiving groove 42, while another end thereof protrudes from the receiving groove 42 with a proper length so that the elastic element 5 is placed between the motor 1 and the second rotary unit 4.

The first rotary unit 3 and second rotary unit 4 are installed with a first inclined surface 31 and a second inclined surface 41, respectively, which are contacted with one another. As the first rotary unit 3 and second rotary unit 4 rotates with respect to one another, the second rotary unit 4 may axially extrude the elastic element 5. The elastic element 5 suffers from a pressure so that the first rotary unit 3 and second rotary unit 4 have a tendency to restore to the original pint. The washer 7 is installed between one end of the elastic element 5 and the body 9 so that the rotation is more successful. Moreover, a tenon 32 is installed on the first inclined surface 31 for confining a maximum relative rotation angle of the first rotary unit 3 to the second rotary unit 4. The present invention may achieve the same effect as it is used to a motor 1.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An impact absorber of a gears-transmission apparatus, comprising two rotary units which are rotating with each other, means for an elastic element being mounted between the two rotary units so that as a torque is applied to the two rotary units and then the torque is released, the two rotary units have an ability to restore to the original position.

2. The impact absorber of a gears-transmission apparatus as claimed in claim 1, further comprising a motor, one rotary unit is mounted to the motor, and another rotary unit is a gear; the two rotary units rotates and slides with respect to one another.

3. The impact absorber of a gears-transmission apparatus as claimed in claim 1, further comprising a motor, a dynamic gear, a retaining ring, and a shaft; the motor is fixed to a body; the dynamic gear is mounted on the motor; the shaft is protruded from the body; two rotary units are gears and are mounted on the shafts; one rotary unit is engaged to the dynamic gear; the two rotary units rotate and slide with respect to one another; and the retaining ring encloses around the shaft.

4. The impact absorber of a gears-transmission apparatus as claimed in claim 1, wherein the elastic element is selected from one of a group containing a linear spring, a plate spring, or a twisted spring.

5. The impact absorber of a gears-transmission apparatus as claimed in claim 1, wherein the two rotary units are installed with a respective inclined surface; one inclined surface is installed with a tenon for formed a maximum rotary angle of the two rotary units.
